(19) United States
(12) Patent Application Publication
(10) Pub. No.: US 2014/0122778 A1
(43) Pub. Date: May 1, 2014

(54) RAPID NETWORK DATA STORAGE TIERING SYSTEM AND METHODS

(71) Applicant: Unisys Corporation, (US)

(72) Inventor: Steven Michael O'Brien, Malvern, PA (US)

(73) Assignee: Unisys Corporation, Blue Bell, PA (US)

(21) Appl. No.: 13/853,110

(22) Filed: Mar. 29, 2013

Related U.S. Application Data
(60) Provisional application No. 61/617,710, filed on Mar. 30, 2012.

(51) Int. Cl. G06F 3/06

(52) U.S. Cl. CPC G06F 3/0647; G06F 3/0619; G06F 3/067
USPC 711/103; 711/114

(57) ABSTRACT

Systems and methods are disclosed herein to a data storage tiering system comprising at least one storage array; at least one solid state storage unit; and a storage controller in communication with the at least one storage array and the at least one solid state storage unit and configured to combine the at least one storage array and the at least one solid state storage unit into one business tier data container using a virtualization layer and present the business tier data container on a storage area network as one storage array to a server, wherein the storage controller creates a business data tier by combining a partition of the solid state storage unit with the at least one storage array.

### CROSS REFERENCE TO RELATED APPLICATIONS

This non-provisional patent application claims priority under 35 U.S.C. §119 to U.S. Provisional Patent Application Ser. No. 61/617,710, entitled “Rapid Network Data Storage Tiering System and Methods,” filed Mar. 30, 2012, the entire contents of which are hereby incorporated herein by reference.

### TECHNICAL FIELD

The present invention relates generally to data storage management, and more specifically, to data storage management according to business tiering.

### BACKGROUND

Storage as a service is a business model in which a storage providing company rents space in their storage infrastructure to a renting company or individual. Using this business model, the renting company may sign a service level agreement (SLA) with the storage providing company to rent storage space on a cost-per-amount stored basis, such as cost-per-gigabyte stored or a cost-per-transfer. In other words, the renting company pays the storage providing company for use of the storage company's data storage drives. The renting company may enter this SLA for a variety of reasons, such as data backup or for all data access for an enterprise via a storage area network.

In any storage as a service business model, data may be placed in tiers according to a company-defined policy. The data tiers may have different characteristics, such as drive format, access speed, or levels of encryption. In other words, a data tier is a set of hardware with certain specifications used for data storage. A higher performing data tier implements higher performance hardware, and a lower performing data tier implements lower performance hardware. Depending on the number of data tiers requested by the customer, the storage providing company may have many different sets of hardware across the storage area network, which may be very costly.

Conventionally, there are two types of data class tiering: business data tiering (BDT) and performance data tiering (PDT). In general, PDT is a data tiering technology that analyzes how often data is accessed and moves the most frequently accessed data to the highest performing tier and the least frequently accessed data to the lowest performing tier. Operationally, PDT measures the “temperature” of a data block, wherein “warmer” blocks are more frequently accessed and “cooler” blocks are less frequently accessed. This “temperature map” for data blocks is illustrated in FIG. 1. Referring to FIG. 1, an exemplary PDT paradigm 100 has four different temperature based data tiers, a cold tier 102, a cool tier 104, a warm tier 106, and a hot tier 108. For example, the cold tier 102 may be stored on 7,200 RPM hard disks drives with RAID 6 protection, which may be the lowest performing tier. Continuing the example of FIG. 1, the cool tier 104 may be stored on 10,000 RPM hard drive disks with RAID 5 protection, the warm tier 106 may be stored on a 15,000 RPM hard drive disks with RAID 10 protection, and the hot tier 108 may be stored on solid state drives with RAID 10 protection, which may be the highest performing tier. Using the principals of PDT, if a data block in the cool tier 104 eventually becomes frequently accessed, the PDT technology 100 moves the data block to the warm tier 106 or the hot tier 108 depending on how frequently the data block has been accessed. Examples of such PDT technologies are IBM's Easy Tier and EMC's FAST.

BDT, on the other hand, moves data blocks to higher or lower performing tiers based on the data's importance to a company. FIG. 2 illustrates an exemplary BDT paradigm 200. In the BDT paradigm 200, four business tiers are illustrated: a platinum tier 202, which has the highest performance, a gold tier 204, a silver tier 206, and a bronze tier 208, which has the lowest performance. Accordingly, the BDT model, which may be created by an SLA, places data blocks having the highest business importance to a company in the platinum tier 202 so that the company may access those important data blocks quickly, while BDT places data blocks having less business significance in lower performing tiers, such as the silver tier 206 or bronze tier 208. As shown in FIG. 2, the platinum tier 202 may have less than one millisecond of access time, data encryption, a less than one hour recovery point objective (RPO), and a zero recovery time objective (RTO). Continuing the example of FIG. 2, the gold tier 204 may have a 2-4 millisecond access time, data encryption, a less than two hour RPO, and a less than five minute RTO; the silver tier 206 may have a 4-7 millisecond access time, data encryption, a less than four hour RPO, and a less than twelve hour RTO; and the bronze tier 208 may have a 8-10 millisecond. access time, no data encryption, a less than forty-eight hour RPO, and a less than forty-eight hour RTO.

PDT is limited because it is unable to determine the business importance of data. For example, a travel website may have, among other things, a customer reservations application and a data mining application. The customer reservations may randomly arrive whenever a customer books a vacation, but the data mining application constantly runs in the background. If the travel website uses PDT, the PDT algorithm would place the data mining data blocks in the highest performing tier because the data mining blocks would be accessed more frequently than the customer reservations data blocks. From a business standpoint, the travel website places the highest business importance on the customer reservations. So, the PDT algorithm organizes the data tiers in a manner that is contrary to the business importance that the travel website places on the data.

BDT also suffers from limitations. Because businesses may change the way data is valued over time, redundant drives may be required for each tier. For example, a business may have a petabyte (PB) of data stored in the gold tier 204, but eventually the business decides that the PB of data now needs to be stored in the silver tier 206. Because of the possibility that the PB of data in the gold tier 204 may be moved to the silver tier 206, a storage provider must make available a PB of silver storage even if the silver tier 206 is empty. Also, because the business may someday decide that the PB of data should be classified as bronze or platinum, a storage provider must also have available a PB bronze drive and a PB platinum drive, which may remain empty or mostly empty depending on how the business classifies their data. So if a business has one PB of data, four PB of storage space must be made available to the business to account for four business tiers. These redundant drives can be very costly to a storage provider.

In addition, moving large amounts of data from one business tier to another business tier requires the transfer of all of the data from a first business tier drive to a second business tier drive. Transferring a very large block of data could take days or weeks because all of the data must be read from the first business tier drive and also written to the second business tier drive. The delay in transferring data frustrates a customer and also places a great deal of stress on a storage area network that is used to transfer the data.

Finally, when a first company transfers data from a first business tier drive to a second business tier drive, a ghost image of the transferred data remains on the first business tier drive unless it is deleted by a server. When the service provider reallocates the first business tier drive for another purpose, for example, using the first business tier drive for a second company's data, the first company's data may be exposed when the second company's server attempts to access the first business tier drive. This exposure of data creates a security risk for all companies using the storage as a service provider.

As shown by all the problems associated with BDT and PDT discussed above, there is a need for a tiering system that does not suffer from the above discussed limitations.

### SUMMARY

The systems and methods described herein attempt to overcome the drawbacks discussed above by employing performance tiering as part of a comprehensive set of heuristics to actively manage data and ensure compliance with business data class requirements. A virtualization layer provides for rapid migration between business tiers while minimizing costs. The virtualization layer combines data storage disks so that the combined storage arrays may appear to be one storage array to a connected server. The overall performance of the combined data storage array may be easily changed by adding or subtracting higher performing logical units and partitions. In addition, performance data tiering technologies may be implemented to move frequently accessed data blocks to the higher performing storage arrays and partitions.

In one embodiment, a data storage tiering system comprises at least one storage array; at least one solid state storage unit; and a storage controller in communication with the at least one storage array and the at least one solid state storage unit and configured to combine the at least one storage array and the at least one solid state storage unit into one business tier data container using a virtualization layer and present the business tier data container on a storage area network as one storage array to a server, wherein the storage controller creates a business data tier by combining a partition of the solid state storage unit with the at least one storage array.

In another embodiment, a computer implemented method of creating business tiers comprises providing, by a computer, a virtualization layer on a storage controller connected to at least one storage array and at least one solid state storage unit; receiving, by a computer, a request from a server over a storage area network for data storage, wherein the request from the server is to store data in a designated business tier; configuring, by a computer, the at least one storage array into a business tier data container; sizing, by a computer, a capacity of the at least one storage array in the virtualization layer for data storage by the server based on the request sent from the server; and incorporating, by a computer, a partition of a solid state storage unit into the business tier data container, wherein the size of the partition is based on the requested business tier.

In another embodiment, a computer-implemented method of migrating data from a first business tier to a second business tier comprises providing, by a computer, a business tier data container comprising cache memory, at least one storage array, a partition of a solid state storage unit, and a virtualization layer running on a storage controller representing the business tier data container on a storage area network; receiving, by a computer, a request from a server to move the data from the first business tier to the second business tier; altering, by a computer, the capacity of the partition of the solid state storage unit based on the second business tier; altering, by a computer, the amount of cache memory in the virtualization layer; moving, by a computer, data from the solid state storage unit into the at least one storage array if the solid state partition decreased in capacity or from the at least one storage array into the solid state partition of the solid state partition increased in capacity.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates an exemplary paradigm for storing data according to performance data tiering according to an exemplary embodiment.

FIG. 2 illustrates an exemplary paradigm for storing data according to business data tiering according to an exemplary embodiment.

FIG. 3 illustrates a system diagram of a data storage tiering system according to the exemplary embodiments.

FIG. 4 illustrates a method of creating a business tier according to an exemplary embodiment.

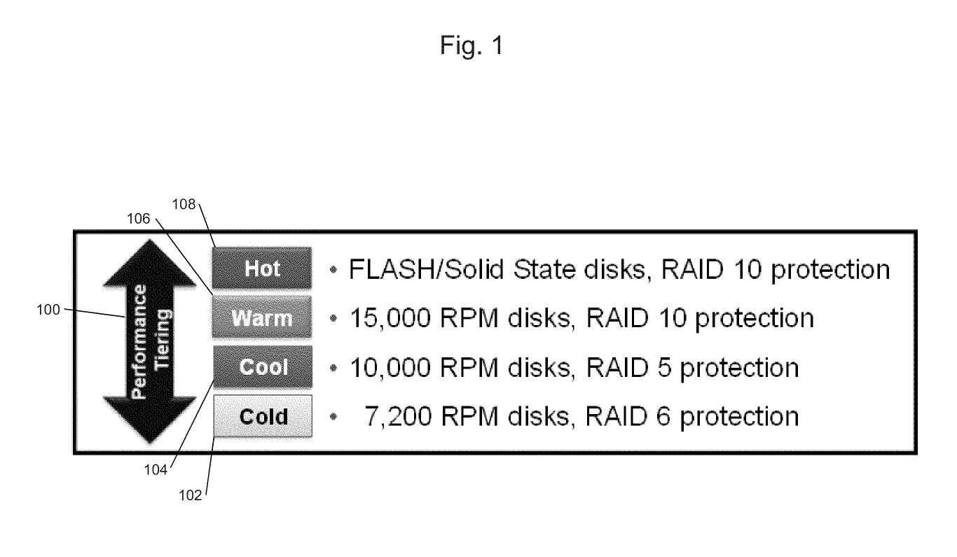

FIG. S illustrates a business tier with a storage controller connected to a server according to an exemplary embodiment.

### DETAILED DESCRIPTION

Reference will now be made in detail to the preferred embodiments, examples of which are illustrated in the accompanying drawings.

The embodiments described above are intended to be exemplary. One skilled in the art recognizes that numerous alternative components and embodiments that may be substituted for the particular examples described herein and still fall within the scope of the invention.

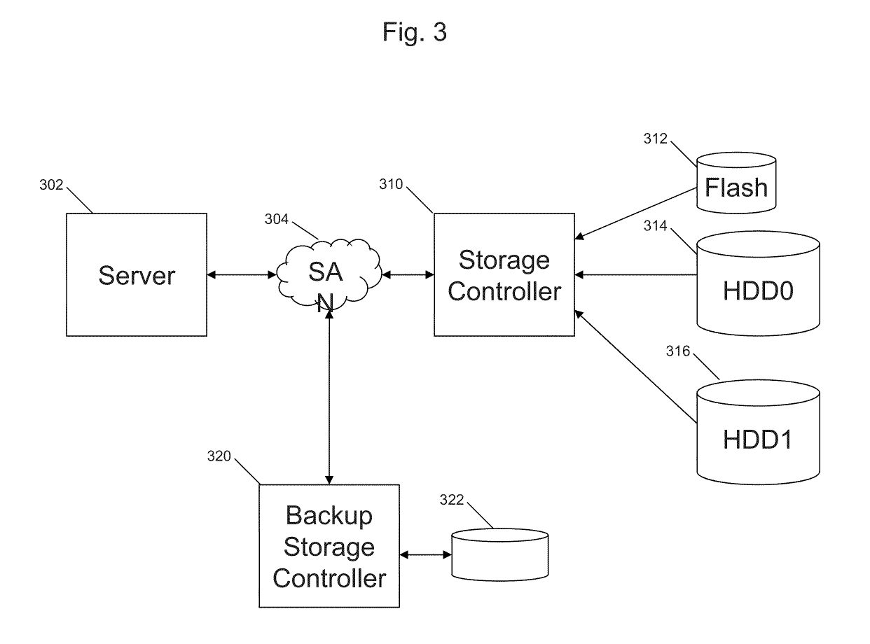

FIG. 3 illustrates a system diagram of a data storage tiering system according to the exemplary embodiments. As shown in FIG. 3, a server 302 accesses a storage controller 310 to store data for the server 302 through a storage area network (SAN) 304. The storage controller 310 receives requests and data from the server 302 and stores data received from the server 302 or provides data to the server 302 through the SAN 304. The received and provided data may reside on a plurality of logical units (LUNs) 312, 314, 316. Each LUN 312, 314, 316 may comprise a storage array or a logical disk. The data stored on the LUNs 312, 314, 316 may be stored in a format of data blocks or files, and the blocks or files may be stored on one LUN or across multiple LUNs, depending upon the method by which the storage controller 310 saves data.

The LUNs 312, 314, 316 may be disk arrays or solid state drives (SSD). The disk arrays may be enterprise storage platforms, such as an EMC VNX or a NetApp V-series storage platform. The disk arrays may include hard disk drives (HDD), cache, disk array controllers, power supplies, and other technology for enterprise storage. In the example of FIG. 3, one SSD 312 and two disk arrays 314 and 316 are connected to the storage controller. The SSD 312 may be a NAND flash memory storage disk, and the disk arrays 314, 316 may include a magnetic data storage device, but any type of SSD or disk array drive may be used. Alternatively, only the storage controller 310 may store data only on SSDs, but at least one SSD is connected to the storage controller 310. The LUNs 312, 314, 316 may be any size in terms of data storage capacity, but preferably the LUNs 312, 314, 316 are jumbo data containers capable of storing large amounts of data for the server 302. Due to the cost difference between disk arrays and SSDs, the disk arrays 314, 316 likely have much more data capacity than the SSD 312. The disk arrays may include cache memory, and the storage controller 310 may also include cache memory. If no cache is included, the SSD 312 may be used as a cache memory. The SSD 312 may be a solid state drive or a solid state disk array.

While the storage controller 310 uses multiple LUNs 312, 314, 316 to store data for the server 302, the storage arrays 312, 314, 316 may store data across multiple LUNs using redundant array or independent disks (RAID) technology. There are multiple levels of RAID, which have different levels of protection, mirroring, parity, fault tolerance, and data storage. The storage controller 310 may implement any RAID level to combine the LUNs 312, 314, 316 into a storage array. In some embodiments, the business tier decides the RAID level implemented by the storage controller 310. For example, the highest performing business tiers may implement RAID 10, while lower performing business tiers may implement RAID 5 or 6.

The storage controller 310 may be a special purpose computer designed to provide storage capacity along with advanced data protection features. The storage controller 310 combines the LUNs 312, 314, 316 into a business tier data container using a virtualization layer above the LUN level. The virtualization layer allows the storage controller 310 to present the LUNs 312, 314, 316 as one storage array on the SAN. The virtualization layer gives the storage controller 310 the flexibility to preconfigure the LUNs 312, 314, 316 into any size. Also, the virtualization layer creates a layer of technology between the LUNs 312, 314, 316 and the server 302. Using the virtualization layer, the storage controller 310 may utilize technology such as performance data tiering (PDT). Also, the virtualization layer provides the storage controller the flexibility to change an amount of cache presented to the server 302 as well as how much storage capacity of the LUNs 312, 314, 316 is partitioned. Finally, the virtualization layer, using advanced data storage techniques like PDT and cache write-through, is able to create any business tier requested by the customer by altering how the LUNs 312, 314, 316 are utilized.

Business tiers may be a set of performance specifications for data storage and retrieval, and the performance specifications may be set by a customer or by a data storage provider. If business data tiering (BDT) is implemented across the SAN, the storage controller 310 may present the LUNs 312, 314, 316 as one business tier data container meeting the specifications of a designated business tier, even if the LUNs 312, 314, 316 have differing specifications that independently may represent a plurality of different business data tiers. By combining the LUNs 312, 314, 316 according to the methods of the present disclosure, the storage controller may present different business tiers to the server 302 by varying the combination of LUNs 312, 314, 316.

The storage controller 310 also replicates data stored on the LUNs 312, 314, 316 for data protection and disaster recovery. The storage controller 310 may replicate the data by interfacing with a backup storage controller 320 over the SAN 304. The backup storage controller 320 may also connect to a plurality of LUNs, although FIG. 3 illustrates that only one LUN 322 provides data storage for the backup storage controller 320. The backup storage controller 320 saves the replicated data from the storage controller 310 on the LUN 322. The backup storage controller 320 may have all of the same features of the storage controller 310, or the backup storage controller 320 may have fewer features than the storage controller 310 since it is only used for backup and not for business data tiering.

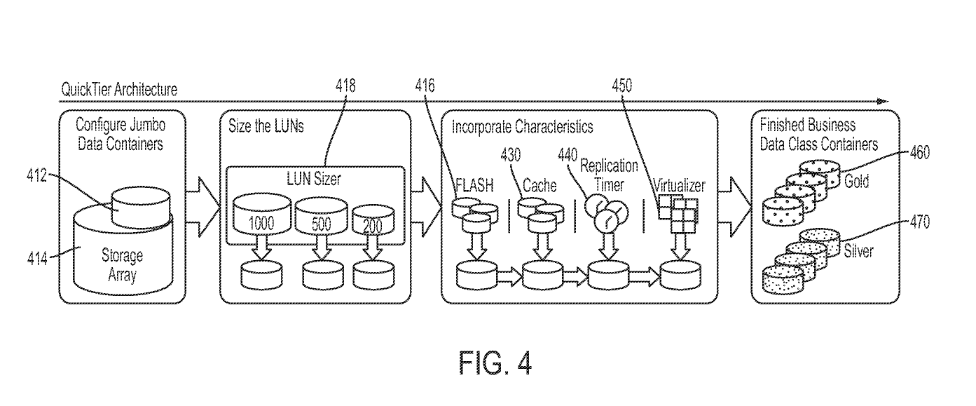

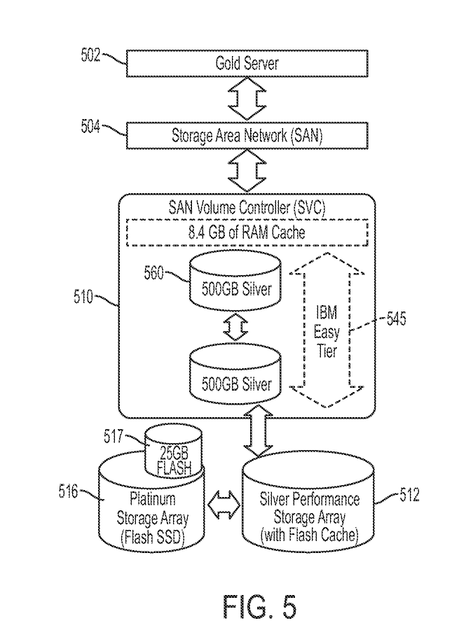

FIG. 4 illustrates how business tiers are created according to the exemplary embodiments. The data storage tiering system according to the exemplary embodiments uses disk arrays 412 and 414 and sizes the disk arrays 412, 414 according to preconfigured business sizes. The capacity of the disk arrays 412, 414 may be sized according to a request from a connected server. As the disk arrays 412, 414 are configured, the data storage tiering system creates preconfigured and sized LUNs 418. The disk arrays 412, 414 may be a plurality of storage arrays combined and partitioned to create the properly sized LUNs 418. As described above, the disk arrays 412, 414 may include other hardware and features such as a storage controller, cache, and virtualization layers. The sizing of the disk arrays 412, 414, and the capacity presented to the SAN may be controlled by the virtualization layer.

While the sizes of the LUNs may be preconfigured, the data storage tiering system may use thin provisioning to meet a customer's needs. Thin provisioning provides flexibility in resizing the LUNs for customer needs, which may be less or more than the size of the preconfigured LUNs.

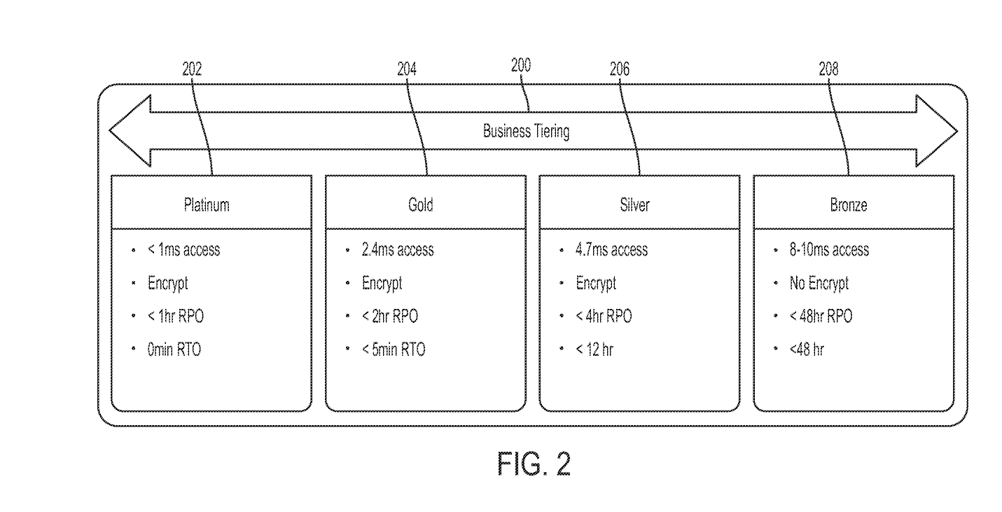

In the exemplary embodiments and detailed description below, the data storage tiering system forms four business tiers, and for example, may be the platinum, gold, silver, and bronze business tiers illustrated in FIG. 2. However, using the system and techniques described below, any number of business tiers may be created. However, for illustration purposes, the four business tiers shown in FIG. 2 will be described.

In the conventional business tiering method, four different business tier storage arrays are configured and available for data storage. Each of the four different storage arrays have different performance levels and different hardware. For example, a gold HDD may spin at a higher RPM than a silver HDD so that the access time of the gold storage array is lower than the silver storage array. The data storage tiering system according to the exemplary embodiments may use any disk array with any specifications. For example, only silver class HDDs may be used to create platinum, gold, and silver business tiers. Because of the flexibility of the data storage tiering system, the storage provider may use existing disk arrays without the need to purchase new storage arrays to meet a company's desired service level. Also, the existing disk arrays may have any type or performance specification, which provides even more flexibility.

Referring again to FIG. 4, after the data storage system sizes the HDDs into LUNs, SSDs 416 in the form of Flash memory are combined with the LUNs. The SSDs 416 have higher performance in terms of access time than the LUNs 412, 414 because SSDs 416 do not have any moving mechanical parts. By combining higher-performing SSDs 416 with LUNs 412, 414, the overall performance of the business tier data container is increased according to how much flash memory 416 is included in the business tier data container. Thus, by adjusting the amount of flash memory 416 included in the business tier data container, a new overall performance of the business tier data container may be created.

In addition to the flash memory 416, the data storage tiering system adds cache 430 to the business tier data container. Cache memory 430 may behave in different ways according to the different business tiers. For example, the amount of cache memory 430 may be reduced for lower performing business tiers. For example, a lowest performing business tier, such as the bronze business tier, may not have any cache memory 430, and a storage controller writes data directly to the bronze storage array. The virtualization layer can remove any cache 430 in any business tier so that data is written through the cache 430. However, in general, higher performing tiers have more cache 430 than lower performing tiers. The cache memory 430 may be included in a standard LUN. For example, a silver class LUN may have 96 GB of cache 430 included in the LUN.

After allocating cache 430 to the business tier, the data storage tiering system adds remote replication settings 440. The remote replication settings 440 remotely replicate data to another site to protect against failure, which is typically replicated at the array level.

All of the LUN 412, 414 sizing and preconfiguring may be controlled by the virtualization layer 450 that exists between the storage arrays and the storage area network. The virtualization layer 450 performs the sizing the storage arrays into LUNs 418 and also performs the combination of the disk arrays 412, 414, the cache 430, the flash memory 420, and the replication settings 440. After this combination is performed, the virtualization layer 450 gives the business tier data container the appearance of one logical drive on the SAN. By implementing the virtualization layer 450 above the combination of storage arrays, a business tier is created, and the business tier data container appears on the SAN as one logical drive even though it is a combination of at least one disk array and at least one SDD. It should be noted, that business tiers may exist that do not require a combination of an SDD and a HDD. For example, a customer may require that a platinum tier have the same performance characteristics of a SSD. In this case, a business tier data container may be mostly comprised of a SSD or entirely comprised of a SSD. On the other hand, a customer may only have need for a business tier that has the performance characteristics of a HDD. In this case, the data storage tiering system may omit the combination of a HDD with a SDD, or the data storage tiering system may use the SSD as additional cache memory.

The virtualization layer 450 performs performance data tiering PDT within the business tier data container created by the combination of storage arrays 412, 414, cache 430, and other settings. Referring to FIG. 4, to increase the performance of a business tier data container, the virtualization layer 450 may move the most frequently accessed data blocks into the SSD 416 of the business tier data container, and less frequently accessed data blocks into the disk arrays 412, 414. Once all of the elements are combined together using the virtualization layer 450, a first business tier 460 and a second business tier 470 may be created.

As shown in FIG. 5, the combination of a silver performance storage array 512 with a partition 517 of flash memory 516 from a platinum storage array SSD creates a gold business tier data container 560. The amount of flash memory 516 used to create a gold business tier data container may be a relatively small when compared to the size of the silver storage array 512 because the PDT 545 effectively uses the flash memory 516 that is allocated for higher performance. FIG. 5 illustrates that only 25 GB of flash memory 516 is included in the combination with 500 GB of silver storage array 512.

The storage controller 510, which creates the virtualization layer, gives the business tier data container of the 500 GB silver storage array 512 and the 25 GB of flash memory 517 the appearance of a 500 GB gold business tier data container 560. Thus, whenever a gold server 502 requests access to a gold business tier through the SAN 504, the business tier data container created by the storage controller 510 is able to receive and conduct the gold server's 502 requests.

A platinum business tier data container may also be easily created by simply increasing the amount of flash memory 516 combined with the silver storage array 512. If necessary, the combination of silver storage array 512 and flash memory 516 may be replaced entirely by platinum flash memory, but the access time requirements of a platinum business tier may be replicated by increasing the amount of flash memory 516 that is included in the business tier data container. Further, PDT 545 may move data blocks such that, for example, hot and warm data blocks are included in the flash memory while cool and cold data blocks are stored in the silver storage array 512.

The business tier data container created by the virtualization layer may also have additional features. For example, encryption of data may be included for certain business tiers. For example, higher performing business tiers, such as the gold and platinum tiers may encrypt all of the data stored in the gold and platinum business tier data containers. The virtualization layer may have a setting to switch encryption on and off. The virtualization layer is also configured to duplicate the encrypted data while encrypted and compress the encrypted data if necessary. Another feature that may be included for lower performing business tiers is a compressor to compress data. For example, bronze data, or data contained in the lowest performing business tier, may be compressed up to 50% in size by the compressor.

The storage controller 510 conserves data storage space on the storage array by only storing what is written by a server 502. The storage controller 510 may return zeros for the rest of the storage array 560. Further, algorithms in the virtualization layer may actively remove ghost images and removed data. Using these algorithms, if a storage provider reallocates a storage array 560, private data will not become exposed to other servers.

When business tier data containers are created according to the exemplary embodiments, a data storage provider may respond to a customer request to move data from one tier to another quickly and easily. For example, if a customer requests that 500 GB of Gold data be moved to a silver business tier, the data storage provider commands the virtualization layer to remove the 25 GB of flash memory, reduce the amount of cache, and adjust any other settings, such as encryption and compression.

Thus, changing from one business tier to another business tier no longer requires moving all 500 GB of data from a gold storage array to a silver storage array. Instead, the majority of the data does not move, and a small percentage of the data moves from an SSD to a disk array, or vice versa. Also, the virtualization layer simply changes its settings and appearance on the SAN.

Because data migration requires very little data to be moved, the amount of stress on the SAN is lowered. Also, the amount of time to change from one business class to another requires hours rather than weeks. And, perhaps most importantly, since data remains mostly on the same LUN, ghost images are not created for the entire set of data. Without ghost images remaining on the SAN, data remains protected and the risk for exposure is limited.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing” or “computing” or “calculating” or “determining” or “displaying” or “generating” or “synchronizing” or “outputting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated. circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A data storage tiering system comprising:
at least one storage array;
at least one solid state storage unit; and
a storage controller in communication with the at least one storage array and the at least one solid state storage unit and configured to combine the at least one storage array and the at least one solid state storage unit into one business tier data container using a virtualization layer and present the business tier data container on a storage area network as one storage array to a server, wherein the storage controller creates a business data tier by combining a partition of the solid state storage unit with the at least one storage array.

2. The data storage tiering system of claim 1, wherein the virtualization layer performs performance data tiering on data stored in the business tier data container such that data accessed most frequently is placed in the solid state partition.

3. The data storage tiering system of claim 1, wherein the business tier includes a set of performance specifications relating to data access and storage.

4. The data storage tiering system of claim 2, wherein the virtualization layer also partitions cache memory included in the at least one storage array according to the business tier.

5. The data storage tiering system of claim 4, wherein a higher performing business tier receives more cache memory than a lower performing business tier.

6. The data storage tiering system of claim 4, wherein the lowest performing business tier receives no cache memory and data is written directly into the business tier data container.

7. The data storage tiering system of claim 1, wherein the virtualization layer implements thin provisioning.

8. The data storage tiering system of claim 2, wherein the business tier data container includes more storage from the solid state storage unit for higher performing business tiers.

9. The data storage tiering system of claim 1, wherein the virtualization layer replicates data stored in the business tier data container by communicating with a second storage controller and sending a copy of the data to be stored on a redundant storage array controlled by the second storage controller.

10. The data storage tiering system of claim 1, wherein more than one storage array may be combined into a storage unit using redundant array of independent disks (RAID) technology.

11. The data storage tiering system of claim 10, wherein the RAID level is determined based on the business tier.

12. The data storage tiering system of claim 3, wherein the storage controller determines whether to encrypt data stored on the business tier data container based on the business tier.

13. The data storage tiering system of claim 3, wherein the storage controller determines whether to compress data stored on the business tier data container based on the business tier.

14. The data storage tiering system of claim 1, wherein the solid state storage unit comprises flash memory.

15. A computer implemented method of creating business tiers comprising:
providing, by a computer, a virtualization layer on a storage controller connected to at least one storage array and at least one solid state storage unit;
receiving, by a computer, a request from a server over a storage area network for data storage, wherein the request from the server is to store data in a designated business tier;
configuring, by a computer, the at least one storage array into a business tier data container;
sizing, by a computer, a capacity of the at least one storage array in the virtualization layer for data storage by the server based on the request sent from the server; and
incorporating, by a computer, a partition of a solid state storage unit into the business tier data container, wherein the size of the partition is based on the requested business tier.

16. The computer-implemented method of claim 15, further comprising:
performing, by a computer, performance data tiering on data stored in the business tier data container such that data accessed most frequently is placed in the solid state partition.

17. The computer-implemented method of claim 15, wherein the business tier includes a set of performance specifications relating to data access and storage.

18. The computer-implemented method of claim 17, further comprising:
partitioning, by a computer, cache memory included in the at least one storage array according to the business tier.

19. The computer-implemented method of claim 18, wherein a higher performing business tier receives more cache memory than a lower performing business tier.

20. The computer-implemented method of claim 18, wherein the lowest performing business tier receives no cache memory and data is written directly into the business tier data container.

21. The computer-implemented method of claim 18 wherein the virtualization layer implements thin provisioning.

22. The computer-implemented method of claim 17, wherein the business tier data container includes more storage from the solid state storage unit for higher performing business tiers.

23. The computer-implemented method of claim 17, further comprising
replicating, by a computer, data stored in the business tier data container by communicating with a second storage controller; and
sending, by a computer, a copy of the data to be stored on a redundant storage array controlled by the second storage controller.

24. The computer-implemented method of claim 15, wherein more than one storage array may be combined into a storage unit using redundant array of independent disks (RAID) technology.

25. The computer-implemented method of claim 24, wherein the RAID level is determined based on the business tier.

26. The computer-implemented method of claim 17, further comprising:
encrypting, by a computer, data stored on the business tier data container based on the business tier.

27. The computer-implemented method of claim 17, further comprising
compressing, by a computer, data stored on the business tier data container based on the business tier.

28. The computer-implemented method of claim 15, wherein the solid state storage unit comprises flash memory.

29. A computer-implemented method of migrating data from a first business tier to a second business tier comprising:
providing, by a computer, a business tier data container comprising cache memory, at least one storage array, a partition of a solid state storage unit, and a virtualization layer running on a storage controller representing the business tier data container on a storage area network;
receiving, by a computer, a request from a server to move the data from the first business tier to the second business tier;
altering, by a computer, the capacity of the partition of the solid state storage unit based on the second business tier;
altering, by a computer, the amount of cache memory in the virtualization layer;
moving, by a computer, data from the solid state storage unit into the at least one storage array if the solid state partition decreased in capacity or from the at least one storage array into the solid state partition of the solid state partition increased in capacity.

30. The computer-implemented method of claim 29, further comprising:
commencing, by a computer, performance data tiering if the first business tier did not have performance data tiering and the second business tier requires performance data tiering.

31. The computer-implemented method of claim 29, further comprising:
halting, by a computer, performance data tiering if no solid state memory is used for the second business tier.
